(19) United States
(12) Patent Application Publication
(10) Pub. No.: US 2011/0289717 A1
(43) Pub. Date: Dec. 1, 2011

(54) Hand-held multi-function brush system with sprays

(76) Inventor: Jay Dhanvanthari, Agoura Hills, CA (US)

(21) Appl. No.: 12/931,210

(22) Filed: Jan. 27, 2011

Related U.S. Application Data
(60) Provisional application No. 61/336,778, filed on Jan. 27, 2010.

(51) Int. Cl. A46B 13/02; B60S 3/04; B08B 3/00; B24B 7/00; B05B 1/00; F26B 19/00; A46B 15/00; A46B 9/06

(52) U.S. Cl. 15/322; 15/105; 15/21.1; 15/320; 15/53.2; 451/67; 239/589; 34/90; 134/115 R

(57) ABSTRACT

The present invention is a hand-held device that integrates and enables one or more or a combination of functions of spraying, cleaning, drying, waxing, polishing and shining of a floor or a surface including that of a vehicle. The present invention has one or more brushes rotated by one or more electric motors powered by a power source or a built-in and/or removable and/or rechargeable battery pack or by water pressure and is capable of discharging, dispersing or spraying one or more or a combination of air, water, steam, compressed air, pressurized water, pressurized steam, hot air, detergent, waxing agent and polishing agent. The discharging, dispersing or spraying of one or more or a combination of these materials through select nozzles along with the rotation of the brush or brushes enables multiple functions to be accomplished in a single pass of the device over the surface.

### CROSS REFERENCE TO RELATED APPLICATION

This is a continuation, in part, of provisional patent application No. 61/336,778 filed on Jan. 1, 2010 now allowed, and priority based thereupon is claimed.

### FIELD OF INVENTION

The present invention relates to hand-held devices for cleaning, drying, polishing and shining of surfaces including that of a vehicle (Class 15 Brushing, Scrubbing and General Cleaning).

### STATEMENTS REGARDING FEDERALLY SPONSORED RESEARCH OR DEVELOPMENT

Not Applicable

### REFERNCE TO SEQUENCE LISTING, A TABLE OR A COMPUTER PROGRAM LISTING COMPACT DISC APPENDIX

Not Applicable

### BACKGROUND OF THE INVENTION

U.S. Pat. No. 5,715,558 deals with dual axis suspension for car wash wrap brush. This is for a fixed car wash system.

U.S. Pat. No. 4,270,958 deals with a rotating plastic flexible brush shaft to turn the front corner and rear corner of a vehicle. This applies to fixed or installed car wash systems.

U.S. Pat. No. 3,693,206 deals with a plurality of brushes for a fixed car wash installation (system).

U.S. Pat. No. 3,772,724 deals with a wrap around car wash brush apparatus for a fixed car wash alley (fixed system).

U.S. Pat. No. 3,339,565 deals with a vehicle washing apparatus in a fixed designated washing alley or space.

United States Patent Application 20020148907 deals with a portable spray for a car wash system. This again deals with an installed or fixed car wash system.

U.S. Pat. No. 4,471,503 deals with a fluid-powered brush in a vibrating motion for cleaning surfaces while the present invention deals with an integrated device functioning with motorized or water powered tubular or longitudinal brush or brushes, and by its rotation or spin and a combination of agents such as detergent, waxing agent, polishing agent to perform one or more of spraying, cleaning, waxing and polishing of a surface including that of a vehicle.

### ADVANTAGES OF THE INVENTION COMPARED TO PRIOR ART

Motorized brushes are utilized for cleaning of the tires and rim areas and floors. These are mostly circular or disc-shaped brushes. The bristles of a motorized brush utilized for cleaning the tire is generally hard for the body of vehicles These motorized brushes are not suitable for and/or not efficient for the cleaning the body of a vehicle or a large surface area.

In the case of a commercial vehicle washing system that is fixed or installed, motorized brushes are utilized that spin along with sprays of one or more of water, air, detergent and wax. The drying is done by either a blast of air to push away water and/or by hand wiping with a drying material such as towel or chamois leather.

Motorized cleaning systems exist such as that of a “car wash or vehicle wash” that are fixed systems or installed facilities.

These fixed or installed systems are large, bulky and heavy and are not suitable for hand-held operation of a motorized brush for cleaning, drying, polishing and shining of a surface including that of a vehicle.

### DEFINITIONS

Device: Device is the present invention

Guide wheel or wheels: One or more wheels on which the device rests and enables smooth movement over a surface.

Splashguard: One or more covers over the brush or brushes to contain or minimize splashing around when one or more brushes rotate.

Surface: The surface including that of a floor, wall, vehicle, container, and rail car including horizontal, vertical, near vertical or angular and curved surfaces that the device is targeted to work on.

### OBJECTS OF THE INVENTION

It is the object of this invention to increase the ease and efficiency of hand operation of one or more or a combination of discharging, dispersing or spraying water and other materials, cleaning, drying, polishing and shining of a surface including that of a vehicle by integrating and providing options for and including one or more or a combination of the functions of spraying, cleaning, polishing and shining by incorporating one or more nozzles for spraying, one or more attachments for sources of discharging, dispersing or spraying materials and one or more cylindrical or tubular motorized brushes or inter-changeable brushes - all in one pass of the device over the surface being worked on.

It is the object of this invention to support the device on one or more wheels—‘guide wheels’—made of non-marking material such as plastic, rubber or a combination or compound of suitable materials, that enable the device to be moved over the surface being cleaned and enable the brush or brushes to operate from or at a uniform height over the surface thereby enabling uniform contact with the surface.

It is the object of this invention that these guide wheels also make it easy to move the brush over the surface to be cleaned compared to any hand held brush without guide wheels and compared to hand motion for scrubbing surface of a vehicle or other surface with a towel or sponge, or compared to drying by hand wiping with a towel or sponge or other material or polishing by hand with a towel or chamois leather.

It is the object of this invention that the longitudinal or cylindrical motorized brush or brushes of the invented device minimizes or eliminates missing areas on the surface to be cleaned compared to hand motions or circular or disc shaped brushes that cover smaller areas at a time.

It is the object of this invention to minimize or eliminate splashing with one or more splash protection guard or guards while the brush or brushes rotate and/or while the materials are discharged, dispersed or sprayed.

It is the object of this invention that the device is hand-held and operated.

### BRIEF SUMMARY OF THE INVENTION

The current invention provides a motorized hand-held device for cleaning, drying, waxing, polishing and shining of a surface including that of an automobile, floors, windows and walls. It provides an option to operate with one or more of water, air, detergent, waxing agent, polishing agent and can be fitted with separate brushes designed for one or more of cleaning, drying, waxing, polishing and shining. The device enables accomplishing multiple functions of spraying, cleaning, drying, waxing, polishing and shining in one go or with one pass. The device may also be utilized to spray and clean in the first pass, and during a second pass, it may be utilized to dry, polish and shine. The device covers a greater surface area including that of a vehicle with each pass compared to any other existing hand-held device, including washing by hand, and thus requiring less effort to cover the area including all sides or vertical or near vertical surfaces. The device works on a vertical or near vertical surfaces including the sides of an automobile, walls and windows by either holding the device in a vertical or near vertical position or by attaching the device in a vertical or near vertical position to a height adjustable and collapsible support tube with one or more wheels at the bottom that enable smooth movement on the floor around the vertical or near vertical surface. For floors, the device is set on the floor and has an option to attach to a hand held height-adjustable and angle-adjustable handle to reach out to the hands of a standing person. The invention is portable and can be handled conveniently for operation including in a parking lot, in a garage or on a typical driveway or street side where an automobile is commonly parked.

The device can be utilized for any surface including that of floors, counter tops, walls and windows.

It is also compact for storage. It is activated either by connecting to a power source and a water source or a water pack and in the case of a DC unit, it can be activated by its own battery pack. All other liquids of choice such as detergent, waxing agent, polishing agent can be added or attached to the device.

### DRAWINGS

FIG. 1 depicts key components of the Device with motor mounted at one end.

FIG. 2 depicts the flow lines and optional attachments for materials.

FIG. 3 depicts an optional support for vertical or near vertical applications.

FIG. 4 represents an outline of a Device with motor at one end, collapsible handle and

FIG. 5 highlights the flow lines for the materials

FIG. 6 is a close-up of the spray nozzles and sprays.

FIG. 7 depicts part of a brush that has longer fibers or bristles at one end

FIG. 8 depicts an alternate construction of a Device with a motor and handle at the mid section.

FIG. 9 depicts a collapsible and angle adjustable support with wheel at the lower end for vertical or near vertical application.

FIG. 10 depicts two-piece brush with nozzles, guide wheels, cover with motor, handle and attachment provisions for materials at the mid section.

FIG. 11 is a close-up of a center-mounted motor with two-piece brushes that are spring loaded.

FIG. 12 depicts a two-motor two-brush device with motors mounted at one end.

FIGS. 13, 14 and 15 depict a Device with mid section mounted motor and two-piece spring-mounted brushes on the surface of a vehicle.

FIG. 16 depicts a Device with mid-section mounted motor being supported by a vertical or near vertical attachment with one or more wheels at the lower end.

FIG. 17 depicts alternate close up view of a Device with mid section mounted motor.

### DETAILED DESCRIPTION OF THE INVENTION

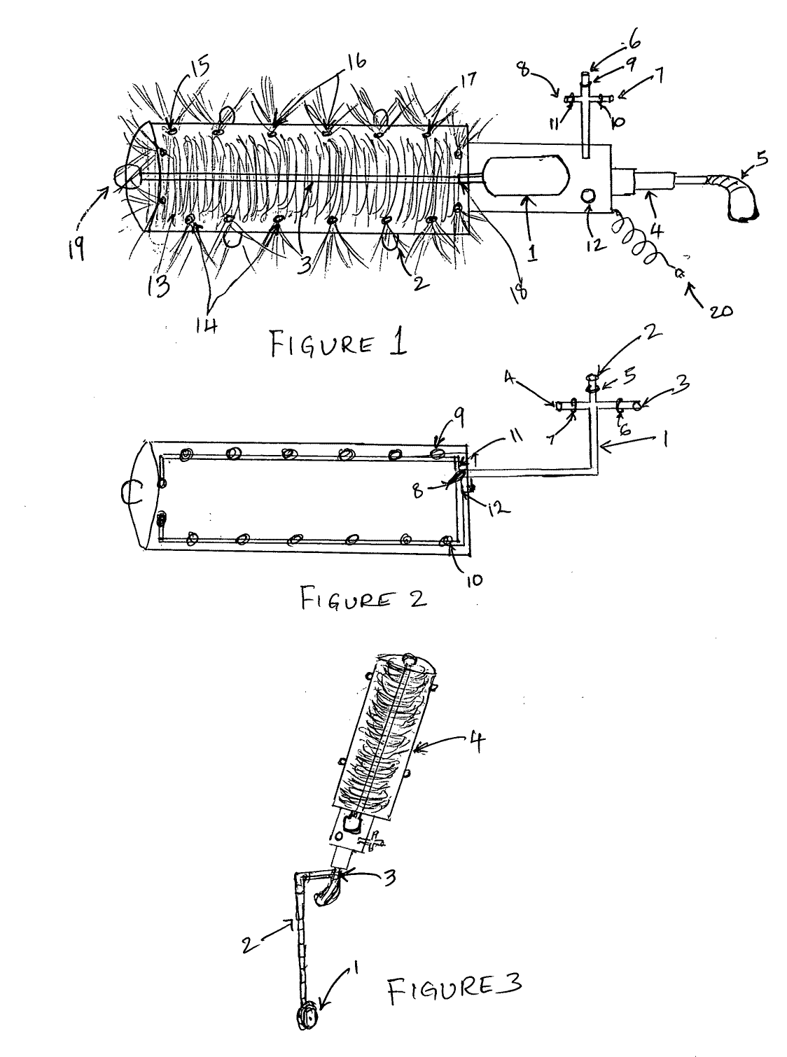

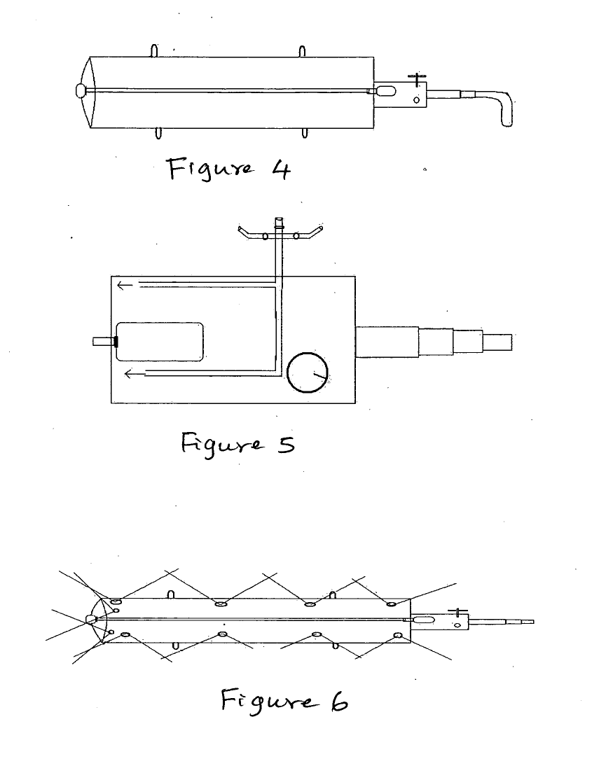

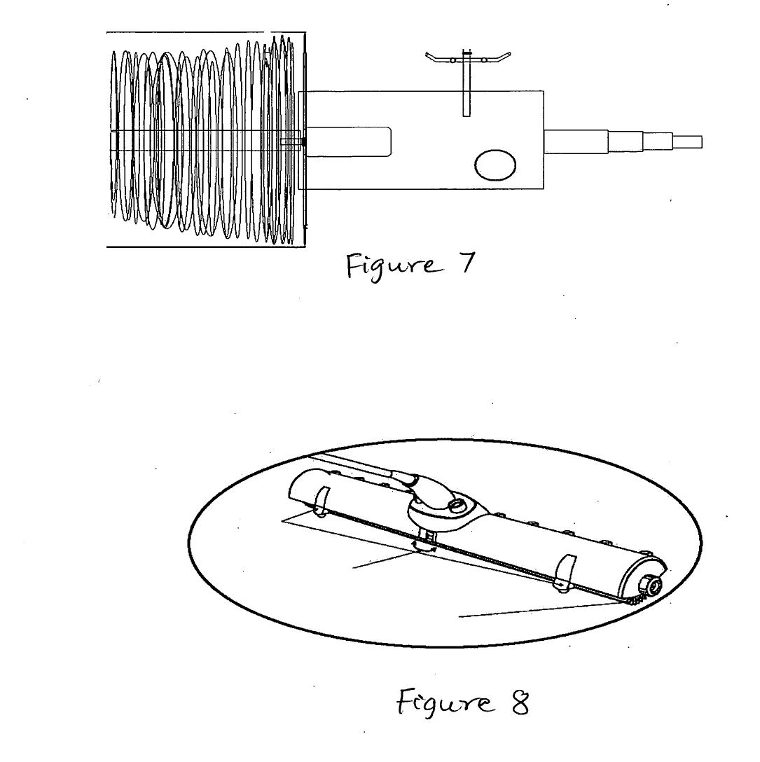

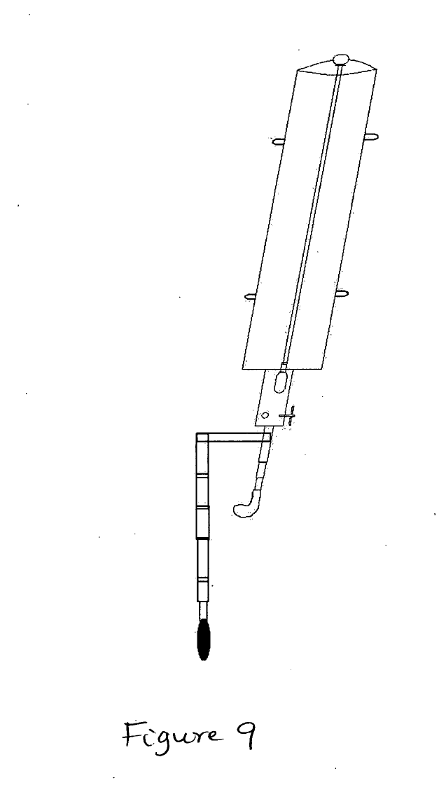

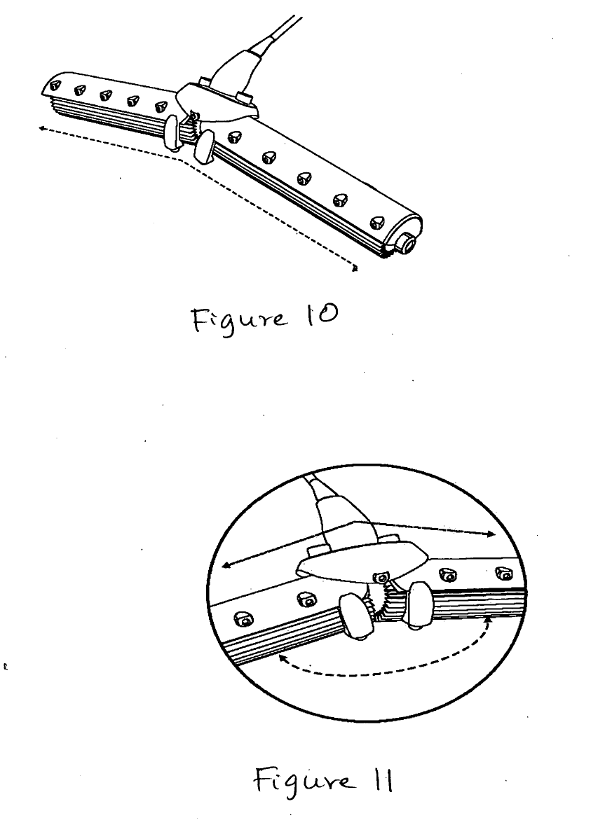

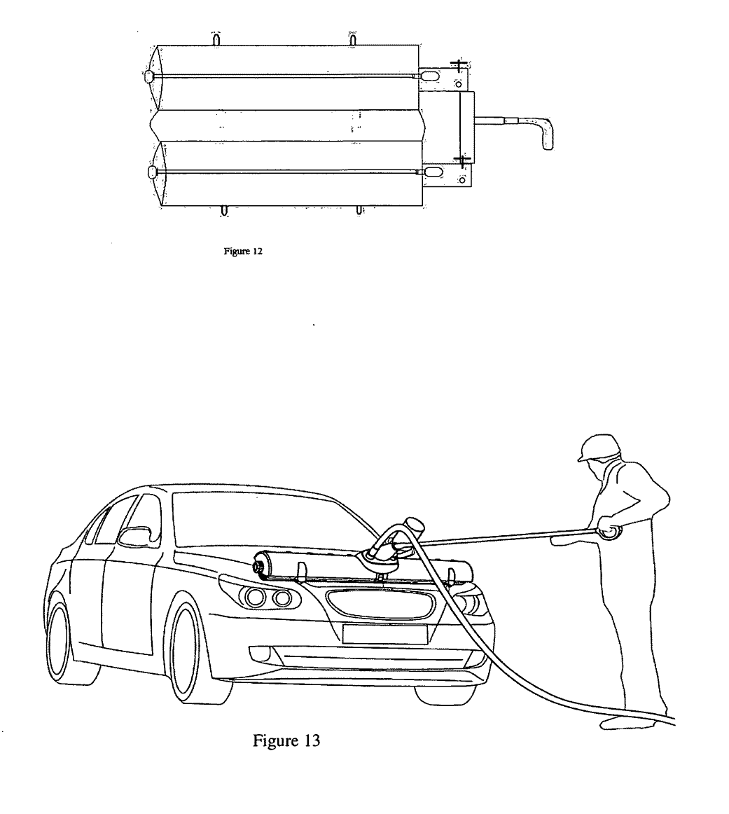

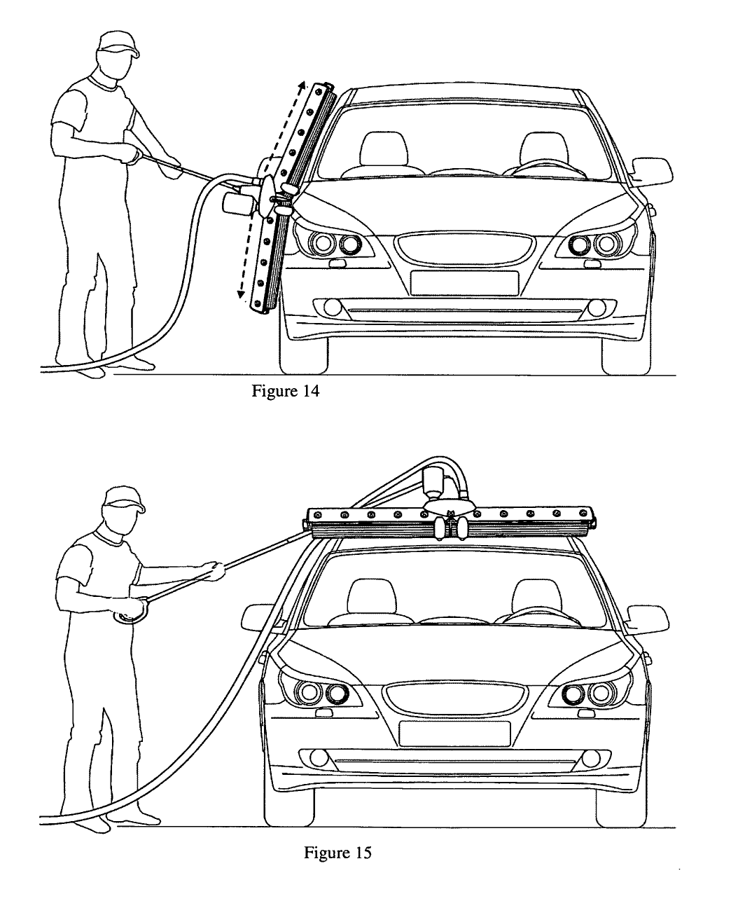

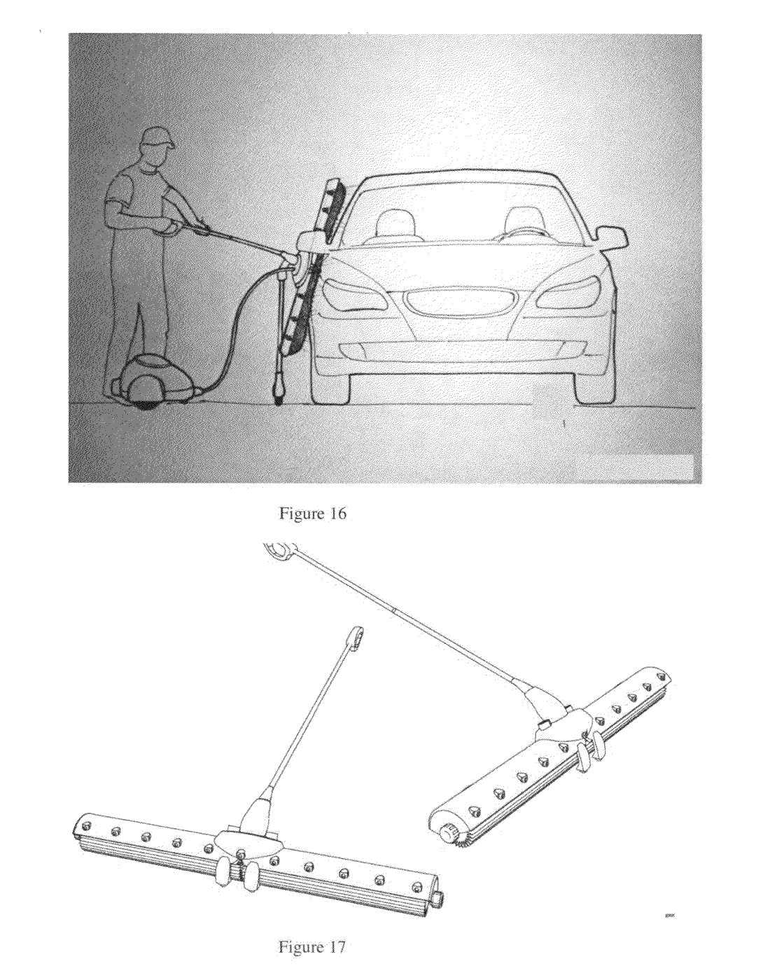

The present invention is a device wherein an axle, core or shaft 18 of a longitudinal or tubular brush 3 of FIG. 1 is attached to an electrically driven motor 1 of FIG. 1 that can be turned off, on, and speed of which is controlled by a control 12 of FIG. 1. The device has options for multiple attachments 6, 7 and 8 of FIG. 1 for water, detergent and a waxing or polishing agent. The flows of these materials are controlled including On, Off and rate of flow by valves 9, 10 and 11 of FIG. 1 respectively. The device has a detachable and collapsible handle 4 of FIG. 1 with a grip 5 of FIG. 1. The device has a splashguard 13 that covers all of the top and a part of the sides of the brush. The device has multiple nozzles such as 13,14,15,16,17 of FIG. 1 that are all connected to one of two supply lines.

The flow lines for above referred attachments 6, 7 and 8 of FIG. 1 are shown in greater detail in FIG. 2 along with supply lines 11 and 12 of FIG. 2 that are connected to a series of nozzles such as 9 and 10 of FIG. 2. The supply lines are controlled including On, Off and rate of flow by valve 8 of FIG. 2. The supply originates from attached materials to provisions 2, 3 and 4 of FIG. 2 the flow of which are controlled for On, Off and rate of flow by valves 5, 6 and 7 of FIG. 2.

The device rests and moves by manual force on one or more guide wheels 2 of FIG. 1.

The brush is detachable and attachable by a knob 19 of FIG. 1.

The device has a connector 20 of FIG. 1 to a power source or is run by a battery pack.

The device has an optional attachment of a collapsible and angle adjustable support 2 of FIG. 3 that has one or more wheels 1 of FIG. 3 at the lower end and may attached by bracket 3 of FIG. 3 to the device 4.

The brush 3 of FIG. 1 has bristles or strips that may be longer towards both ends and tapered gradually to the rest of the sections

### DESCRIPTION OF THE INVENTION IN TERMS OF FUNCTIONS IT PERFORMS

### Spray to Loosen Dirt and Clean

The present invention (hereinafter referred to as “the device”) sprays from one set of nozzles on the advancing side of the device one or more or a combination of air, water, steam, compressed air, pressurized water, pressurized steam, detergent, waxing agent and polishing agent for the surface to be cleaned. As the device is moved by hand, the sprayed surface is cleaned by the rotating bristles of a brush or brushes. The device has an option for a second set of sprays located on the following side of the device, which spray on the area brushed to wash away any loosened particles on the surface.

For drying, the brush is changed to a ‘drying brush’ and the device spins the brush and absorbs the moisture on the surface to be dried. During this operation, the spray lines may be turned to OFF.

For polishing, the brush is changed to a ‘polishing brush’, and a waxing and/or polishing material can be discharged, dispersed or sprayed by a set of nozzles on the ‘advancing side’ of the device as the rotating brush or brushes spread the waxing agent and/or polishing agent evenly on the surface. The brush or brushes by their rotation or spin give the surface a ‘rub’ or ‘wipe’ to wax and/or to polish the surface.

Alternatively, the waxing agent and/or the polishing agent may be discharged, dispersed or sprayed along with and during the cleaning cycle and the polishing brush may be utilized without a spray.

A third option is to combine polishing with drying cycle by utilizing a common brush that is suitable for both purposes or, in the case of a device with multiple brushes, the device can have at least one brush for drying and one brush for polishing.

The device has options to operate the brush or brushes without any sprays (set to OFF) and the sprays may be operated without any brush rotation (set to OFF).

### Cover the Area in Just a Few Passes

The surface to be cleaned and/or waxed and/or polished say, that of a vehicle, can be covered in just a few passes of the device.

### Attachments

The device has provisions for attachments including that of water container or a water hose, detergent container, waxing agent container and/or polishing agent container. The device also has an attachment for a power source. Devices with battery packs may have a detachable re-charging connector for power source.

### Controls

The device can be controlled with ‘on’, ‘off’, and ‘rate of flow’ controls for including, water or detergent, air, heated air, steam, pressurized water, compressed air, pressurized steam and waxing material and polishing material. Each and every nozzle may have the capability to be turned on, off and to adjust the angle and force of dispersion of the spray. The device may have one or more control valves to shut off or turn on the flow of material to one or more of the spray lines. The device includes controls for speed of rotation of every brush along with ‘on’ and ‘off’ controls.

### Guide Wheels

The device has one or more non-marking guide wheels to move the device smoothly over the surface to be cleaned and to keep the brush or brushes at a uniform height over the surface to be cleaned thereby ensuring a uniform contact of the bristles with the surface.

### Clean Vertical or Near Vertical Surfaces

The device has a retractable handle with a grip. The device can be maneuvered on and around vertical or near vertical sides with the help of a retractable and height adjustable vertical attachment or, support that has one or more wheels at the lower end to move the device smoothly on the floor, thereby enabling the brush to operate in a vertical or near vertical position with the guide wheels contacting the surface to be cleaned and rolling the motorized brush or brushes with the help of the guide wheels to maintain a uniform height or distance over the surface being worked on.

### Interchangeable Brushes for Cleaning, Drying and Polishing or Shining

The device has the capability to operate interchangeable brushes to enable changing to specialty brushes such as one for cleaning, one for drying and one for waxing or polishing the surface and in the case of a device with multi brushes, it can perform multiple functions of one or more of cleaning, drying, polishing and shining in one single pass.

### Collapsible and Height-Adjustable and Angle-Adjustable Handle

The unit has a handle with a grip. The handle is detachable from the device. The handle includes a collapsible tubular handle with a grip where a part of the length of the tube can be bent to an angle to enable operation of the brush on a surface that is at higher level than the reach of a person like that of a roof top of a vehicle. The handle includes a type of a collapsible tubular handle thereby enabling adjustability for a specific length or height. The handle's angle from the device is also adjustable to enable rolling the device on a floor with the handle reaching up to the hands of a person in a standing position or to enable rolling the device on the roof of a vehicle that may be above the reach of a person.

I claim:

1. A hand-held device or gadget comprising of one or more or a combination of discharging system or spraying system, cleaning system, drying system, polishing system and shining system with a capability to perform one or more or a combination of functions of discharging or spraying, cleaning, drying, polishing and shining.

2. A hand-held motorized device or gadget consisting of one or more brushes including longitudinal or tubular brush or brushes that are rotated by one or more motors powered by a power source or a built-in battery pack and/or removable and/or rechargeable battery pack or by water pressure.

3. A hand-held device or gadget with one or more nozzles for discharging, dispersing or spraying of one or more or any combination of water, pressurized water, steam, pressurized steam, air, pressurized air, heated air, detergent, waxing agent, polishing agent and shining agent.

4. A device or gadget as in claim 2 with the capability to detach and attach an alternate brush or brushes.

5. A device or gadget as in claim 2 where the brushes including soft and light-weight brushes are capable of one of more or combinations of cleaning, drying, waxing and/or polishing including uneven surfaces or projections and other curved surfaces by virtue of and including long, fine, flexible bristles, strips or other shapes and sizes made of one or more or combination of materials including foam, polyester, nylon and chamois leather.

6. A device or gadget as in claim 2 where the brush or brushes to include brush fibers or strips that are longer towards either ends of a brush and tapered to the remaining part of the brush thereby enabling more effective contact of curved surfaces like those along the periphery of an automobile.

7. A device or gadget as in claim 3 with one or more provisions for attaching of one or more of water container, water hose, steam, pressurized steam, air, pressurized air, heater air, detergent container, waxing agent container and polishing agent container.

8. A device or gadget as in claims 2 and 3 with one or more orifices or nozzles with options to discharge, disperse or spray one or more or combinations of the materials noted in claim 3 above through an optionally selected set of orifices or nozzles from at least one flow line connecting the sources of materials noted in claim 3 above to the orifices or nozzles on the advancing side of the device and/or an option to connect to the orifices or nozzles on the following side of the device.

9. A device or gadget as in claim 7 with capability to draw and/or mix any one or more of the materials noted in claim 3 above through gravity or suction or force of water, steam, air, pressurized water, pressurized steam or pressurized air or a combination thereof that is passing through the spray line and to direct the flow into any one or more spray lines and/or nozzles.

10. A device or gadget as in claim 8 with capability to discharge, disperse or spray through a set of nozzles including on the surface that is just ahead of the reach of the bristles of the rotating brush and movement of the device.

11. A device or gadget as in claim 8 with capability to discharge, disperse or spray through a set of nozzles including on the surface following the contact by the rotation of the brush and on the rotating brush fibers that has just contacted the surface.

12. A device or gadget as in claims with capability to control including On, Off and rate of flow for each of the connected materials and spray lines.

13. A device or gadget as in claim 8 with capability to control one or more or a combination of On, Off, force and angle of dispersion from each nozzle

14. A device or gadget as in claims 1, 2 and 3 with capability to one or more of move, roll, pull or push the device by hand over the surface to be cleaned with the support of one or more ‘guide’ wheels that may be of a non-marking material.

15. A device or gadget as in claims 1, 2 and 3 with a collapsible and height or length-adjustable handle or extension tube which may include an ergonomically designed grip.

16. A device or gadget as in claims 1, 2 and 3 with an optional attachment of a collapsible and height adjustable support including a tubular shape with one or more wheels at the lower end attachable to the device at or near the other end to position the device on a vertical or near vertical surface including a wall or sides of a vehicle.

17. A device or gadget as in claims 1, 2 and 3 with one or more handles with grip or grips including one or more detachable and/or collapsible tubular handle or handles whose length or heights are adjustable and where a part of the length of the collapsible tube can be adjustable to an angle to enable operation of the brush on a surface that is at a higher level than the reach of a person like that of a roof top of a vehicle and to enable rolling the device on a floor with the handle reaching up to the hands of a person in a standing position.

18. A device or gadget as in claims 1, 2 and 3 with one or more covers including splash protection guards covering all or part of the top and all or part of the sides of the brush or brushes and/or the device.

19. A device or gadget as in claim 2 with multiple brush or brushes, which are slightly hinged and/or spring-loaded.
